(19) United States
(12) Patent Application Publication
(10) Pub. No.: US 2016/0281398 A1
(43) Pub. Date: Sep. 29, 2016

(54) SECURITY LATCH FOR A SWING BAR DOOR GUARD

(71) Applicant: Alan B. Kingsbury, Campbellsville, KY (US)

(72) Inventor: Alan B. Kingsbury, Campbellsville, KY (US)

(21) Appl. No.: 14/938,106

(22) Filed: Nov. 11, 2015

Related U.S. Application Data
(60) Provisional application No. 62/137,220, filed on Mar. 23, 2015.

(51) Int. Cl. E05C 17/16; E05B 17/20

(52) U.S. Cl. CPC E05C 17/166; E05B 17/2088

(57) ABSTRACT

The security latch for a swing bar door guard includes a post, a cross member connected to one end of the post, and a plate connected to a second, opposing end of the post. The plate can be installed adjacent to or formed with the rigid arm component of a swing bar door guard assembly to prevent the release of the swing bar from its retaining rod when the door is slightly ajar. The post and narrower dimension of the cross member can pass between the two swing bar arms. When the post and cross member are turned ninety degrees the cross member extends across the swing bar arms to prevent any substantial movement thereof. The post is frictionally mounted in the plate to hold its orientation when set. The plate and post are provided with stops to limit post and cross member rotation to no more than ninety degrees.

### CROSS-REFERENCE TO RELATED APPLICATION

The present disclosure claims priority to U.S. Provisional Patent Application Ser. No. 612/137,220 filed on Mar. 23, 2015, entitled “SECURITY LATCH FOR A SWING BAR DOOR GUARD”, the entirety of which is incorporated herein by reference.

### FIELD OF INVENTION

The present invention relates generally to latches, locks, and related devices, and particularly to a security latch for a swing bar door guard that prevents the swing bar from being opened from the opposite side of the door when the security latch is engaged with swing bar.

### BACKGROUND OF INVENTION

Various supplementary mechanical guards are known for securing doorways in a partially opened or ajar state. The most common of these supplementary guards are the chain type and the swing bar type comprising a knobbed arm affixed to one panel (generally the door) and a slotted bar (generally a staple configuration) pivotally attached to the adjacent structure (usually the jamb). The swing bar is pivoted over the knobbed arm to prevent the door from being more than slightly opened, with the arm passing through the narrower slot or passage between the swing bar members and the larger diameter knob of the arm preventing the swing bar from clearing the knob. These supplementary guards are common installations not only in the home, but also in hotels, motels, and other quarters throughout the world.

However, various means have been developed for defeating these supplementary guards, if the door is slightly ajar with the latch engaged. This may occur in a hotel or motel room if the door lock is opened by a staff member or other person with access to a key to the room. One way of defeating the swing bar door guard mechanism once the door has been unlocked and is ajar, is by drawing the door slightly toward its closed position and inserting a fairly stiff member (card stock paper, thin plastic or sheet metal, etc.) through the gap between the door and the jamb, using the paper or other member to push the swing bar clear of the arm, and then opening the door. Thus a security latch for a swing bar door guard solving the aforementioned problems is desired.

### BRIEF SUMMARY OF THE INVENTION

The security latch for a swing bar door guard essentially includes a plate installed adjacent to or formed with the rigid arm component of the swing bar door guard assembly. The plate has a post pivotally secured thereto, and extending normal to the plane or surface of the plate. The distal end of the post, i.e., the end opposite the plate, includes a cross member thereon so the post and its cross member collectively form a T configuration.

The cross member has a span or length greater than the spacing between the two members of the swing bar, but the post and narrower width of its cross member fit easily between the two swing bar members. Thus, the swing bar may be prevented from releasing the arm when engaged therewith by moving the swing bar over the post and cross member and then rotating the post and cross member so the cross member extends across the two swing bar members.

The post is preferably frictionally secured in the plate from which it extends, thus requiring some slight effort to rotate the post and its cross member. This assures that the post and cross member will remain in the desired orientation, e.g., with the cross member across the members of the swing bar, once adjusted to this orientation. Stops are provided in or on the plate and extending from the post to limit the rotation of the post and its cross member to ninety degrees, i.e., with the cross member either aligned between the swing bar members or extending across the members. Various embodiments of the stops are provided.

Various embodiments of the plate and its post and cross member are also provided, with one embodiment comprising a plate that is separate from the conventional plate and rigid arm component of the swing bar door guard assembly. This embodiment provides for installation of the security latch with previously installed swing bar door guards. In another embodiment, the plate and its post and cross member are combined with the rigid arm component of the swing bar door guard, thus facilitating installation of the swing bar door guard and the security latch when both are installed together.

These and other features of the present invention will become readily apparent upon further review of the following specification and drawings.

### BRIEF DESCRIPTION OF THE DRAWINGS

To further clarify various aspects of some example embodiments of the present invention, a more particular description of the invention will be rendered by reference to specific embodiments thereof which are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1A is an environmental perspective view of a security latch for a swing bar door guard according to the present invention, showing the security latch engaged to prevent the opening of the swing bar.

FIG. 1B is an environmental perspective view of the security latch for a swing bar door guard of FIG. 1A, showing the security latch turned to allow the swing bar to be opened.

FIG. 1C is an environmental perspective view of the security latch for a swing bar door guard of FIGS. 1A and 1B, showing the swing bar swung open after disengaging the security latch.

FIG. 2 is an exploded perspective view of the security latch for a swing bar door guard according to the present invention, illustrating its various components and features.

FIG. 3 is a perspective view of the security latch for a swing bar door guard according to the present invention, showing further details thereof.

FIG. 4 is a perspective view of an alternative embodiment of the security latch for a swing bar door guard according to the present invention, showing various details thereof.

FIG. 5A is a perspective view of another alternative embodiment of the security latch for a swing bar door guard according to the present invention, wherein the mounting plate for the latch is formed integrally with the arm mounting plate of the swing bar assembly.

FIG. 5B is a perspective view of the alternative embodiment of the security latch for a swing bar door guard of FIG. 5A, showing the swing bar swung open after disengaging the security latch.

FIG. 6A is an exploded side view another alternative embodiment of the security latch for a swing bar door guard according to the present invention, wherein the mounting plate for the latch is formed integrally with the arm mounting plate of the swing bar assembly.

FIG. 6B is a perspective exploded view of the alternative embodiment of the security latch for a swing bar door guard of FIG. 6A, showing the swing bar swung open after disengaging the security latch.

FIG. 7 is a perspective assembly view of the alternative embodiment of the security latch for a swing bar door guard of FIGS. 6A and 6B, showing the swing bar swung open after disengaging the security latch.

Similar reference characters denote corresponding features consistently throughout the attached drawings.

### DETAIL DESCRIPTION OF THE INVENTION

The security latch for a swing bar door guard includes a post, a cross member connected to one end of the post, and a plate connected to a second, opposing end of the post. The plate can be installed adjacent to or formed with the rigid arm component of a swing bar door guard assembly. The post is selectively pivot able to align the cross member with the slot between the swing bar members for passage there through, or to cross the swing bar members to prevent their release. The security latch for a swing bar door guard can prevent the release of the swing bar from its retaining rod when the door is slightly ajar.

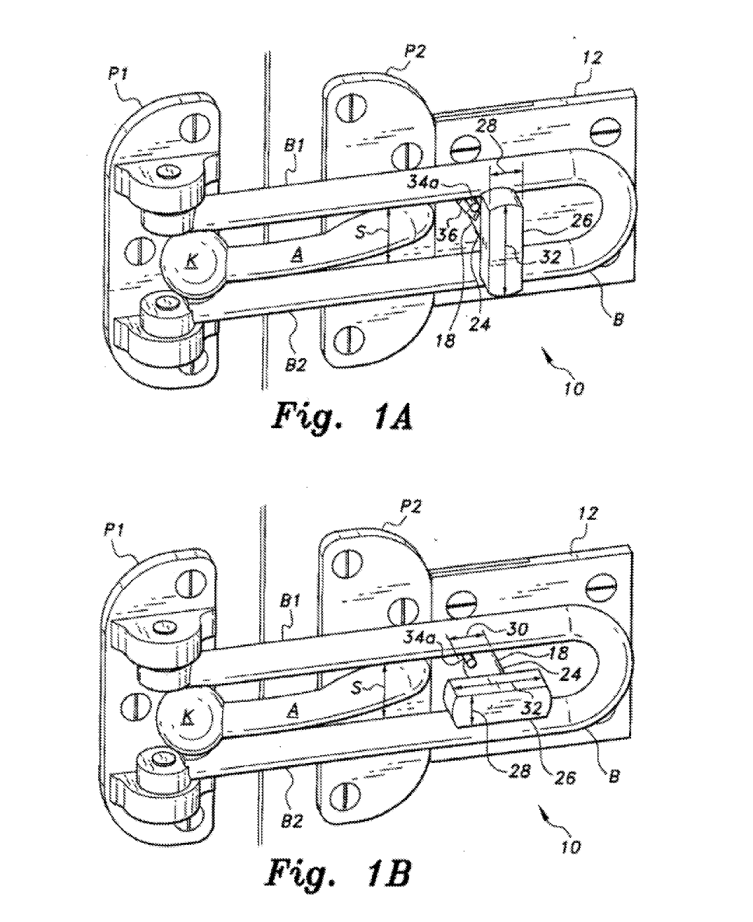

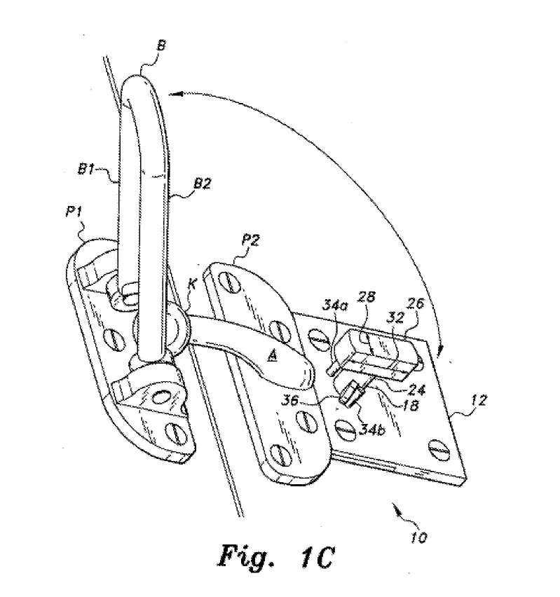

FIGS. 1A through 3 provide illustrations of a first embodiment of the security latch for a swing bar door guard, designated as security latch 10. The swing bar door guard can be conventional, having a pivotally acting swing bar B extending from a swing bar mounting plate P1, generally affixed to the door jamb, with a retaining arm A affixed to an arm mounting plate P2, generally affixed to the edge of the door. The swing bar B is formed by two parallel members B1 and B2 having the general configuration of an elongate U. The two members B1 and B2 have a span S there between and define an arm passage for the rigid retaining arm A of the assembly. The arm A has a knob K formed on its distal end, with the knob K passing through a wider gap at the base of the swing bar B but being captured by the relatively narrower span S between the two parallel swing bar members B1 and B2.

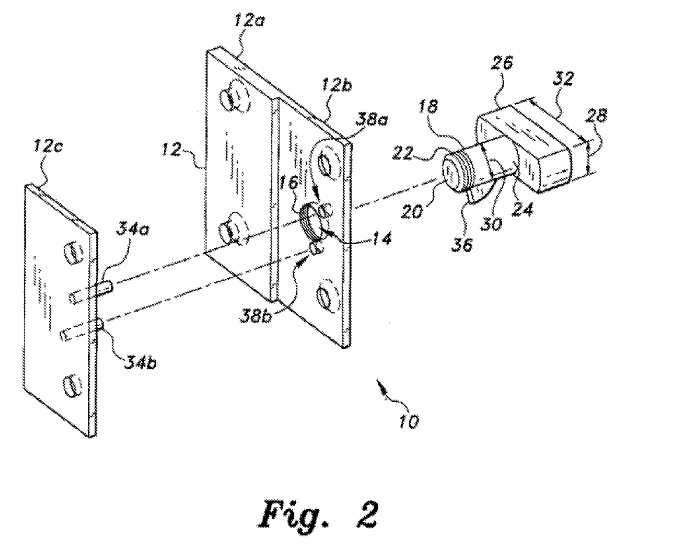

The security latch 10 includes a rigid plate 12 having a post passage 14 (shown in FIG. 2) formed therein. The post passage 14 may include internal threads 16 therein, as shown in FIG. 2, or may be unthreaded. A post 18 has an attachment end 20 installed in the post passage 14. The attachment end 20 of the post 18 includes external threads 22 to mate with the internal threads 16 of the post passage 14, or may remain unthreaded where the posts passage of the plate is unthreaded. Whether the post 18 is threaded into the post passage 14 of the plate 12 or is otherwise captured therein, the attachment end 20 of the post 18 preferably has a frictional fit within the post passage 14 in order to preclude free rotation of the post 18 relative to the plate 12. The frictional resistance allows a user of the security latch 10 to rotate the post 18 within the plate 12 using a moderate amount of force or pressure, while preventing the post 18 from freely rotating or shifting its position or orientation within the plate 12 due to vibration or other incidental forces or effects.

The post 18 further includes a distal end 24 with a cross member 26 attached thereto. The cross member 26 has a width or minor dimension 28 adapted to pass through the span S between the two swing bar members B1 and B2, with the post 18 having a diameter 30 (indicated in FIGS. 1B and 2) adapted to pass through the span S between the members B1 and B2. The cross member 26 has a length or major dimension 32 greater than the span S between the swing bar members B1 and B2. Thus, when the swing bar B is lowered over the arm A and the plate 12 of the security latch assembly 10, and the post 18 is rotated so that its cross member 26 extends across the two swing bar members B1 and B2 as shown in FIG. 1A, the swing bar B cannot be rotated or lifted away from the security latch plate 12 and the retaining arm plate P2 and thus cannot be manipulated to clear the arm A to allow the door to be opened fully. Rotation of the post 18 and its cross member 26 ninety degrees from the position shown in FIG. 1A, i.e.• to the position shown in FIG. 1B, allows the swing bar B to be pivoted or lifted away from the plate 12 to clear the arm A as shown in FIG. 1C, thereby allowing the door to be opened fully. FIG. 3 clearly shows the two alternative positions or orientations of the cross member 26, with a latched orientation (as in FIG. 1A) shown in solid lines and an unlatched orientation (as in FIGS. 1B and 1C) shown in broken lines.

The security latch also preferably includes means for limiting the rotation of the post 18 and its cross member 26 to a range between the cross member 26 lying parallel to the swing bar B and perpendicular to the swing bar B, i.e., 90 degrees. In the security latch 10 embodiment of FIGS. 1A through 3, this is achieved by post rotational stops comprising first and second stop pins 34a and 34b extending from the plate 12 and normal thereto, adjacent to the post 18, and a radial protrusion extending from the post 18 comprising a flange 36 disposed between the two pins 34a and 34b. The pins 34a and 34b define a semi-circumferential arc of slightly more than 90 degrees there between, to allow for the thickness of the flange 36. The arcuate range of rotation of the post 18 and its cross member 26 from the flange 36 contacting the first pin 34a to contacting the second pin 34b is essentially 90 degrees.

FIG. 2 provides an exploded perspective view of an exemplary construction of the stop pins and plate. The plate 12 can include two portions, a thicker portion 12a and a thinner portion 12b formed as a unitary component. Another plate element 12c is formed as a separate component from the plate component 12a, 12b and seats beneath the thinner plate element 12b when assembled therewith, so that the bottom surface of the plate assembly 12 forms a continuous planar surface to facilitate attachment to the door structure. The two stop pins 34a, 34b are permanently and immovably affixed to the plate element 12c, e.g., by interference fit into corresponding passages, threaded attachment, welding, etc. Stop pin passages 38a and 38b are provided through the thinner portion 12b of the plate 12, with the two stop pins 34a, 34b extending through the corresponding passages 38a, 38b to extend adjacent to the post 18 when the various components of the security latch are assembled with one another, as shown in FIGS. 1A through 1C and 2. This arrangement allows the post 18 to be threaded into the passage 14 of the plate 12, or more specifically the plate portion 12b, through several revolutions without being stopped by the pins 34a, 34b. Thus, the post 18 can be properly threaded into the post passage 14 to the depth required with the stop flange 36 of the post 18 positioned between the two pin passages 38a, 38b. The second plate element 12c can then be installed beneath the thinner portion 12b of the plate 12 with its stop pins 34a, 34b extending through the pin passages 38a, 38b to capture the stop flange 36 of the post 18 there between.

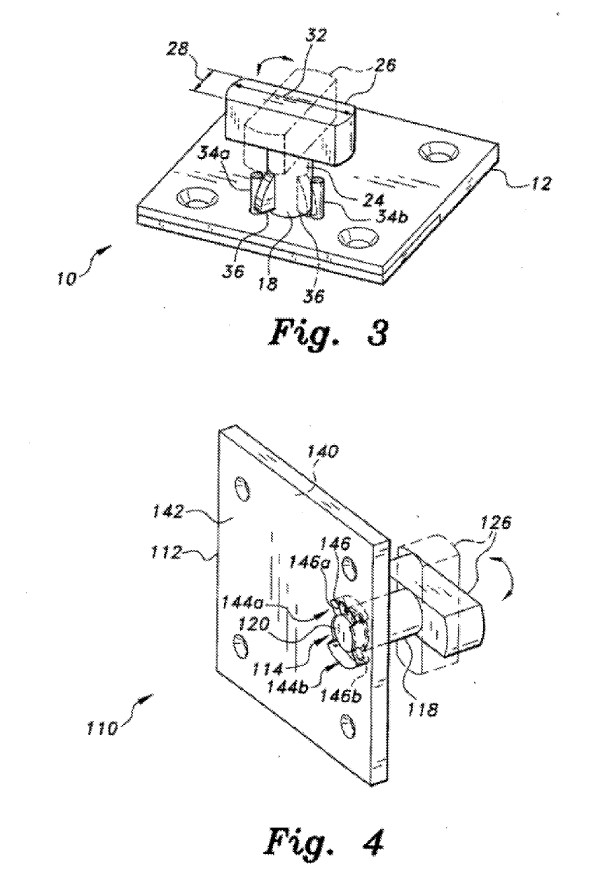

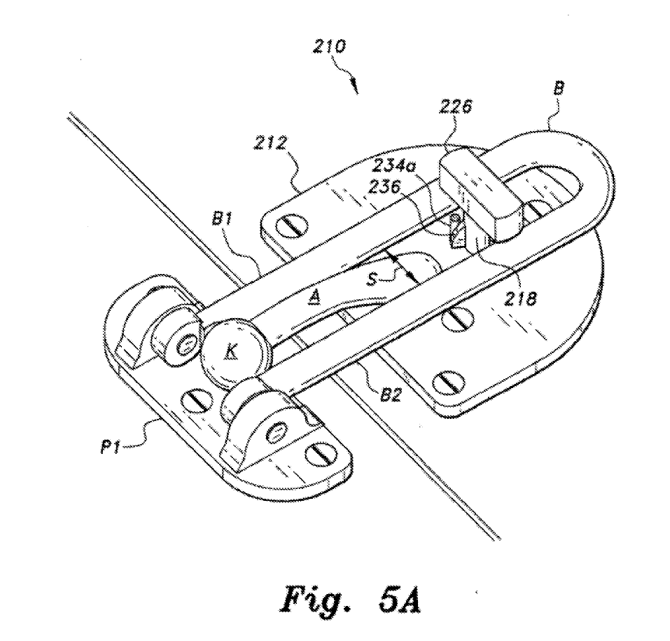

FIG. 4 of the drawings provides a bottom perspective view of an alternative security latch embodiment, designated as security latch 110. The function of the security latch 110 is identical to that of the security latch 10 of FIGS. 1A through 3, but the structure for limiting the rotation of the stop pin is different. The security latch mechanism 110 of FIG. 4 includes a plate 112 having a post passage 114 formed there through. The attachment end, or end portion, 120 of the post 118 preferably forms a tight frictional fit within the post passage 114 of the plate 112 to preclude inadvertent or unintended rotation of the post 118 and its cross member 126. Rather than threading the interior of the post passage 114, the bottom surface 142 of the plate 112 includes post rotational stops comprising diametrically opposed first and second recesses 144a, 144b, each subtending an arc of slightly more than 90 degrees. The attachment end, or end portion, 120 of the post 118 includes a diametrically disposed pin 146 there through, with the pin 146 extending beyond the post 118 to each side thereof to form first and second radially extending protrusions 146a, 146b. The pin 146, or more specifically its extensions 146a and 146b, is captured in the corresponding recesses 144a and 144b to limit rotation of the post 118 and its cross member 126 to no more than 90 degrees. Assembly may be accomplished by driving the post 118 through the post passage 114 beyond its normal operating depth to expose the end portion 120 of the post 118, pressing or driving the rotational stop pin 146 through a diametric passage (not shown) through the end portion 120 of the post 118, and pushing the post 118 back through the post passage 114 to seat the pin extensions 146a and 146b within the corresponding recesses 144a and 144b in the bottom 142 of the plate 112.

The security latch embodiments 10 and 110 described above and illustrated in FIGS. 1A through 4 are adapted for installation with an existing swing bar door guard installation. No removal of any of the components of the existing swing bar door guard installation is needed, as the attachment plate 12 or 112 of the security latch 10 or 110 is a separate component from any of the components of the swing bar door latch. However, in many cases it may be desirable to provide a security latch for a swing bar door guard that is an integral component of the swing bar door guard for new installations.

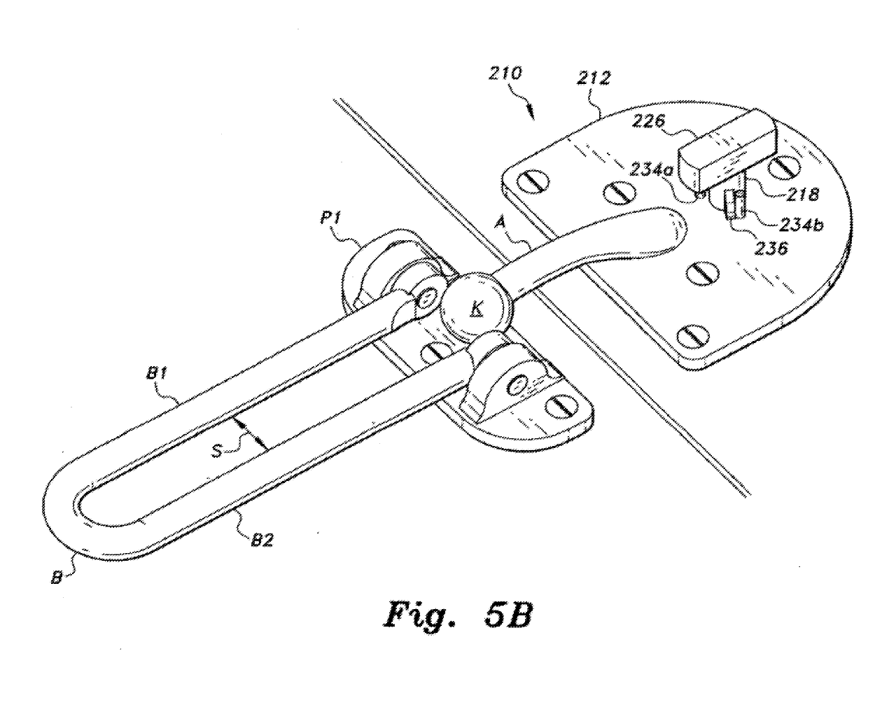

FIGS. 5A and 5B illustrate such an embodiment, designated as security latch 210. The post with its cross member and its stops are essentially the same as those corresponding components of the first embodiment 10 of FIGS. 1A through FIG. 3, comprising a post 218, cross member 226, first and second stop pins 234a and 234b (shown in FIG. 5B), and radially protruding flange 236 in the embodiment 210 of FIGS. 5A and 5B. However, rather than providing a post mounting plate separate from the structure of the swing bar door guard, the embodiment 210 of FIGS. 5A and 1B provides a single common plate 212 that includes the rigid arm A of the swing bar door guard extending therefrom and formed as an integral and unitary component therewith. The swing bar door guard is otherwise similar to the swing bar door guard described further above and shown in FIGS. 1A through 1C, having a pivotally acting swing bar B extending from a swing bar mounting plate P1, generally affixed to the door jamb. The swing bar B is formed by two parallel members B1 and B2 having the general configuration of an elongate U. The two members B1 and B2 have a span S there between and define an arm passage for the rigid retaining arm A of the assembly. The arm A has a knob K formed on its distal end, with the knob K passing through a wider gap at the base of the swing bar B but being captured by the relatively narrower span S between the two parallel swing bar members B1 and B2. The retaining arm A is affixed to the same plate 212 as the security latch assembly 210, as noted further above.

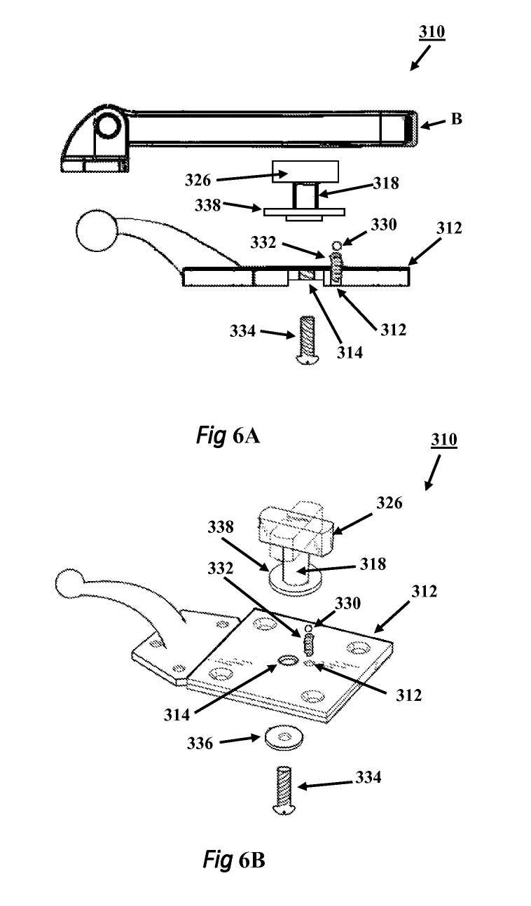

Referring now to FIGS. 6A and 6B, another preferred embodiment is shown wherein the positions of the components of the embodiment 310 in FIGS. 6A and 6B correspond approximately to the positions of the components of the first embodiment 10 in FIGS. 1A and 1C. As shown in FIGS. 6A and 6B, the post 318 defines a circular bottom base portion 338 having underneath a plurality of indentations (not shown). A spring 332 is housed within the plate 12 for supporting a ball bearing 330 wherein when the cross member 326 is pushed downwardly and turned the ball and spring 330 and 332 respectively, are compressed until aligned with an indentation for retaining the post 318 being frictionally captured in the post passage 314 of plate 312 such that the post resists free rotation and retains position as set, the post 318 having a diameter adapted for passage through the arm passage of the swing bar B. The post 318 is held into frictional compression through use of a screw 334 and washer 336 for screwing the post 318, circular base 338 and cross member 326 within plate passage 314 of plate 312.

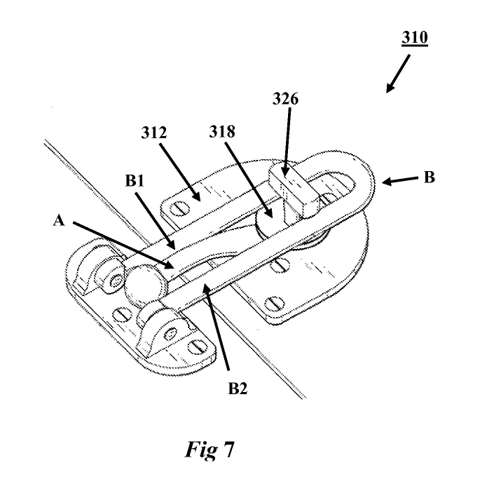

Referring now to FIG. 7, the swing bar B is shown swung over the retaining arm A, in position to prevent the door from being opened more than slightly. The post 318 and its cross member 326 have been turned to position the cross member 326 across the two swing bar members B1 and B2, thus preventing the swing bar B from being moved from its position securing the door. In FIG. 6A, the post 318 and its cross member 326 have been rotated to align the cross member 326 with the elongate gap between the two swing bar members B1 and B2 shown in FIG. 9, allowing the swing bar B to pass clear of the cross member 326 and to be swung or pivoted clear of the security latch assembly 310 and the retaining arm A, thereby allowing the door to which the plate 312 is attached, to be opened.

The post with its cross member and its stops are essentially the same as those corresponding components of the first embodiment 10 of FIGS. 1A through FIG. 3, comprising a post 218, cross member 226, first and second stop pins 234a and 234b (shown in FIG. 5B), and radially protruding flange 236 in the embodiment 210 of FIGS. 5A and 5B. However, rather than providing a post mounting plate separate from the structure of the swing bar door guard, the embodiment 210 of FIGS. 5A and 1B provides a single common plate 212 that includes the rigid arm A of the swing bar door guard extending therefrom and formed as an integral and unitary component therewith. The swing bar door guard is otherwise similar to the swing bar door guard described further above and shown in FIGS. 1A through 1C, having a pivotally acting swing bar B extending from a swing bar mounting plate P1, generally affixed to the door jamb. The swing bar B is formed by two parallel members B1 and B2 having the general configuration of an elongate U. The two members B1 and B2 have a span S there between and define an arm passage for the rigid retaining arm A of the assembly. The arm A has a knob K formed on its distal end, with the knob K passing through a wider gap at the base of the swing bar B but being captured by the relatively narrower span S between the two parallel swing bar members B1 and B2. The retaining arm A is affixed to the same plate 212 as the security latch assembly 210, as noted further above. More specifically, the post 318 and its cross member 326 have been turned to position the cross member 326 across the two swing bar members B1 and B2, thus preventing the swing bar B from being moved from its position securing the door. In FIG. 7, the post 318 and its cross member 326 have been rotated to align the cross member 326 with the elongate gap between the two swing bar members B1 and B2, allowing the swing bar B to pass clear of the cross member 326 and to be swung or pivoted clear of the security latch assembly 310 and the retaining arm A, thereby allowing the door to which the plate 312 is attached, to be opened.

It is to be understood that the present invention is not limited to the embodiments described above, but encompasses any and all embodiments within the scope of the following claims.

What is claimed is:

1. A security latch for a swing bar door guard, the swing bar door guard having a pivotally acting swing bar with first and second parallel members having a span there between and defining an arm passage there between and a rigid arm selectively passing through the arm passage of the swing bar, the security latch comprising:
a rigid plate having a post passage defined there through
a post having an attachment end pivotally captured in the post passage of the plate and a distal end opposite the attachment end, the post having a diameter adapted for passage through the arm passage of the swing bar;
a cross member disposed across the distal end of the post, the cross member having a width adapted for passage through the arm passage of the swing bar and a length greater than the span of the arm passage of the swing bar;

2. The security latch for a swing bar door guard according to claim 1, further including post rotational stops extending from the plate; and
a radially disposed protrusion extending from the post, the post rotational stops selectively engaging the protrusion of the post, whereby rotation of the post relative to the plate is limited to no more than ninety degrees.

3. The security latch for a swing bar door guard according to claim 1, wherein the post defining a circular bottom base portion having underneath a plurality of indentations, wherein a spring is housed within the plate for supporting a ball bearing wherein when the cross member is pushed downwardly and turned the ball and spring are compressed until aligned with an indentation for retaining the post being frictionally captured in the post passage of the plate such that the post resists free rotation and retains position as set, the post having a diameter adapted for passage through the arm passage of the swing bar.

4. A security latch for a swing bar door guard, the swing bar door guard having a pivotally acting swing bar with first and second parallel members having a span there between and defining an arm passage there between and a rigid arm selectively passing through the arm passage of the swing bar, the security latch comprising:
a rigid plate having a post passage defined there through;
a post having an attachment end pivotally captured in the post passage of the plate and a distal end opposite the attachment end, the attachment end of the post being frictionally captured in the post passage of the plate such that the post resists free rotation and retains position as set, the post having a diameter adapted for passage through the arm passage of the swing bar; and
a cross member disposed across the distal end of the post, the cross member having a width adapted for passage through the arm passage of the swing bar and a length greater than the span of the arm passage of the swing bar.

5. A security latch for a swing bar door guard, the swing bar door guard having a pivotally acting swing bar with first and second parallel members having a span there between and defining an arm passage there between and a rigid arm selectively passing through the arm passage of the swing bar, the security latch comprising:
a rigid plate having a post passage defined there through a post having an attachment end pivotally captured in the post passage of the plate and a distal end opposite the attachment end, the post having a diameter adapted for passage through the arm passage of the swing bar;
a cross member disposed across the distal end of the post, the cross member having a width adapted for passage through the arm passage of the swing bar and a length greater than the span of the arm passage of the swing bar;
post rotational stops extending from the plate; and
a radially disposed protrusion extending from the post, the post rotational stops selectively engaging the protrusion of the post, whereby rotation of the post relative to the plate is limited to no more than ninety degrees.
